(19) United States
(12) Patent Application Publication
(10) Pub. No.: US 2023/0054276 A1
(43) Pub. Date: Feb. 23, 2023

(54) CHLORINATED HYDROCARBONS AS LUBRICANTS FOR COILED-TUBING (CT) SUBTERRANEAN DRILLING IN OIL-GAS EXPLORATION APPLICATION

(71) Applicant: Dover Chemical Corporation, Dover, OH (US)

(72) Inventor: Duong Nguyen, Dover, OH (US)

(73) Assignee: Dover Chemical Corporation, Dover, OH (US)

(21) Appl. No.: 17/881,992

(22) Filed: Aug. 5, 2022

Related U.S. Application Data
(60) Provisional application No. 63/229,746, filed on Aug. 5, 2021.

(51) Int. Cl. C10M 173/00; C10M 105/52; C10M 159/12; C10M 135/10; C10M 129/95; C10M 145/30; C10M 167/00; C10M 169/04; C09K 8/08

(52) U.S. Cl. CPC C10M 173/00; C10M 105/52; C10M 159/12; C10M 135/10; C10M 129/95; C10M 145/30; C10M 167/00; C10M 169/048; C09K 8/08; C09K 2208/34; C10M 2211/0206; C10M 2207/402; C10M 2219/044; C10M 2209/105

(57) ABSTRACT

A composition having: 91% to 97% by weight a first component; and 3% to 9% by weight of a second component, the first component having one, two, or three of the following chlorinated-hydrocarbon subcomponents: the first chlorinated-hydrocarbon subcomponent being a plurality of chlorinated hydrocarbons that range from 35% to 45% by weight chlorine, the second chlorinated-hydrocarbon subcomponent being a plurality of chlorinated hydrocarbons that range from 45% to 55% by weight chlorine, and the third chlorinated-hydrocarbon subcomponent being a plurality of chlorinated hydrocarbons that range from 55% to 65% by weight chlorine, the second component being ethoxylated castor oil, calcium alkylbenzene sulfonate, or a combination thereof.

### CROSS-REFERENCE TO RELATED APPLICATIONS

This application claims priority to pending U.S. provisional patent application Ser. No. 63/229,746 filed on Aug. 5, 2022. The subject matter of which is incorporated by reference into this application.

### BACKGROUND OF THE INVENTION

Coiled-tubing drilling is known, and metal-on-metal friction-reducing lubricants are used in coiled-tubing drilling to reduce an amount of friction that results from contact between the metallic coiled-tubing exterior surface and the interior surface of the metal casing within the wellbore. This metal-on-metal friction is commonly steel-on-steel friction.

Drilling lubricants typically reside in drilling or flushing fluids as an emulsion, wherein a drilling lubricant is a dispersed phase within a drilling or flushing fluid continuous phase. These emulsions fill the annulus between the wellbore metal casing and the coiled-tubing exterior surface. And it is because of an emulsion's position between the wellbore metal casing and the coiled-tubing exterior surface that the dispersed-phase lubricant can reduce the metal-on-metal friction resulting from contact between the two metal surfaces.

There remains a need for additional metal-on-metal friction reducing lubricants that can be used in coiled-tubing drilling.

### BRIEF SUMMARY OF THE INVENTION

A composition having: 91% to 97% by weight a first component; and 3% to 9% by weight of a second component, the first component having one, two, or three of the following chlorinated-hydrocarbon subcomponents: the first chlorinated-hydrocarbon subcomponent being a plurality of chlorinated hydrocarbons that range from 35% to 45% by weight chlorine, the second chlorinated-hydrocarbon subcomponent being a plurality of chlorinated hydrocarbons that range from 45% to 55% by weight chlorine, and the third chlorinated-hydrocarbon subcomponent being a plurality of chlorinated hydrocarbons that range from 55% to 65% by weight chlorine, the second component being ethoxylated castor oil, calcium alkylbenzene sulfonate, or a combination thereof.

A composition having: 50.7% to 56.7% by weight a first component; 0.4% to 6.4% by weight a second component; 5.6% to 11.6% by weight a third component; 25.6% to 31.6% by weight a fourth component; and 2.7% to 8.7% by weight a fifth component, the first component having one, two, or three of the following chlorinated-hydrocarbon subcomponents: the first chlorinated-hydrocarbon subcomponent being a plurality of chlorinated hydrocarbons that range from 35% to 45% by weight chlorine, the second chlorinated-hydrocarbon subcomponent being a plurality of chlorinated hydrocarbons that range from 45% to 55% by weight chlorine, and the third chlorinated-hydrocarbon subcomponent being a plurality of chlorinated hydrocarbons that range from 55% to 65% by weight chlorine, the second component being ethoxylated castor oil, calcium alkylbenzene sulfonate, or a combination thereof, the third component having vegetable methyl esters, biodiesels, methyl fatty esters, methyl oleates, methyl palmitates, or a combination thereof, the fourth component having polyglycols, ethers, glycols, or a combination thereof, and the fifth component being tap water.

Chlorinated hydrocarbons are a class of lubricants that can be added into drilling fluids or flushing fluids to treat or to be used in vertical and horizontal wellbores to enable the bottom hole assembly (BHA) to travel or reach beyond 10,000 feet horizontal production zones by reducing the steel-on-steel friction generated by the sliding of a coiled tubing exterior steel surface against the steel casing of an existing wellbore. Based on a newly designed bench test that can accurately predict the field performance of a CT lubricant, e.g., high-sulfur olefins, fatty esters lubricants, or a combination thereof, the chlorinated-hydrocarbon-containing lubricant composition can reduce the metal-on-metal friction between a coiled tubing exterior steel surface and a steel wellbore casing and thereby allow coiled tubing to travel 50 to 110% farther than what is possible by using currently known coiled-tubing lubricants. The lower coefficient of friction enables the drill bit which is located at the end of bottom hole assembly (BHA) to reach the maximum length of a horizontal production zone currently ranging from 10,000 to 25,000 ft laterals, improving oil-gas productivity significantly.

### DETAILED DESCRIPTION OF THE INVENTION

Embodiments are directed to a metal-on-metal friction-reducing lubricant composition that is useful in coiled-tubing drilling applications. In a first embodiment, the composition has two components:
(i) 91% to 97% by weight a chlorinated-hydrocarbon component, and
(ii) 3% to 9% by weight an emulsifier component.

And in a second embodiment, the composition has five components:
(i) 50.7% to 56.7% by weight a chlorinated-hydrocarbon component,
(ii) 0.4% to 6.4% by weight an emulsifier component,
(iii) 5.6% to 11.6% by weight a vegetable methyl esters component,
(iv) 25.6% to 31.6% by weight a component that has polyglycols, ethers, glycols, or a combination thereof, and
(v) 2.7% to 8.7% by weight tap water.

Chlorinated hydrocarbons are commercially available, and useful chlorinated hydrocarbons include chlorinated hydrocarbons that are: 35% to 45% by weight chlorine, 45% to 55% by weight chlorine, 55% to 65% by weight chlorine, or combinations thereof.

Emulsifiers are commercially available, and useful emulsifiers include ethoxylated castor oil, calcium alkylbenzene sulfonate, or a combination thereof. Ethoxylated castor oil is commercially available from Milliken Chemicals Corporation as Synlube™ 728. Calcium alkylbenzene sulfonate is commercially available from Stepan Chemicals Corporation as Ninate™ 401. A useful emulsifier package is available from Dover Chemical as ECP-1366™.

Vegetable methyl esters are commercially available, and useful vegetable methyl esters include biodiesels, methyl fatty esters, methyl oleates, methyl palmitates, or a combination thereof.

Polyglycols, ethers, and glycols are commercially available. Any known polyglycol, any known ether, and any known glycol can be used. Any of these can be used alone or in combination. A useful commercial blend of off-spec or by-products having polyglycols, ethers, and glycols is available from Aloe-Lube, Inc. as Black Max™.

Tap water is known.

Both embodiments are useful as a metal-on-metal friction-reducing lubricant in coiled-tubing drilling. For each embodiment, the metal-on-metal friction-reducing lubricant composition is useful as a dispersed phase in a drilling or flushing fluid continuous phase. Any water-based drilling or flushing fluid can be used as a continuous phase, and low-salt brine is a useful drilling-fluid continuous phase.

In embodiments, the metal-on-metal friction-reducing lubricant composition can be used with a water-based drilling fluid at a relative weight ratio of: (i) 1 to 400, or (ii) 1 to 300-500. The metal-on-metal friction-reducing lubricant composition can be used in coiled-tubing drilling in the same way that other known lubricants are used in a water-based coiled-tubing drilling fluid.

When the compositional embodiments are used in combination with low-salt brine at a relative weight ration of 1 to 400, metal-on-metal friction is reduced by at least 40%. In some embodiments, metal-on-metal friction is reduced by at least 50%. And in some embodiments, metal-on-metal friction is reduced by at least 60%.

### Examples Section

Description of Ofite Testing Method:

The chlorinated-hydrocarbon lubricant blends were evaluated using Ofite Lubricity Meter manufactured and calibrated by Ofite Inc. In this test, the main lubrication mechanism involves the rubbing surfaces from a steel O-ring and Steel Block; both were immersed in the tested fluid and on them a load in pounds were applied and the revolution of spinning O-ring was set at 100 rpm. The tested coiled-tubing or CT fluid was aged in 160 F rolling oven for 16 hours before being tested. We called this preparation “after hot-roll” or AHR samples. Before each tested AHR sample which contained the novel lubricant chlorinated blends at 1 ppb or pound per barrel which was calculated to 0.25 wt %, a blank or plain brine sample without any lubricants is run with Ofite first to establish a baseline of 33 lb-in torque after 10-minute duration of the test. Blank or standard torque was set at 33 lb-in. The immediately the cup containing blank was removed and replaced with another cup which contains the tested CT fluid. The test is then repeated at 100 RPM, without the whole assembly was dismantled or any parameters were reset or adjusted. The final torque, normally the lowest, was recollected and recorded after 10-min test duration. We considered the final test torque is the meaningful one at which the rubbing or friction mechanism has reached a steady state.

Then the percent of friction reduction can be calculated as follows:

% FR=(33 lb-in−torque of tested fluid)/33 lb-in×100

TABLE 1
Coiled-Tubing or CT Fluid Formula
400 g low-salt (5% NaCl salt) brine plus l g of the novel lubricant blend

TABLE II
Typical Formulae of the Novel Dispersible Chlorinated Lubricant Blends

| Ingredients | Formula I | Formula II |
|---|---|---|
| Chlorinated hydrocarbons | 94.0% | 53.7% |
| (40% Cl or 50% Cl or 60% Cl) | | |
| Dover Chemical’s ECP- | 6.0% | 3.4% |
| 1366 emulsifier package (1) | | |
| Vegetable methyl esters | 0% | 8.6% |
| Aloe-Lube Inc.’s Black Max (2) | 0% | 28.6% |
| Distilled water | 0% | 5.7% |
| Total | 100.0% | 100.0% |
| Appearance of the blend | clear | homogenous |

Notes:
(1) ECP-1366 is a commercial blend of emulsifiers designed specifically to disperse chlorinated hydrocarbons in water or brines.
(2) Black-Max is a blend of off-spec or by-products consisted of polyglycols, ethers, and glycols, offered by Aloe-Lube Inc.

Blank or Base of CT Fluids Used in Testing the Novel CT Lubricant Blends:

The base of CT fluids used in this application or the Blank is low-salt (5% NaCl salt) brine, considered as synthetic sea water, which has a torque of 30 lb-in at 150 lbs load and 100 rpm. Thus, the torque of 30 lb-in is used as the standard to calculate all % FR or percents of friction reduction, as follows:

% FR=[(30−resulted torque of tested CT fluid)/30]×100

Logically, % FR is equal to be zero for the blank fluid which contains no CT lubricant blend.

TABLE III
Ofite Testing Results with 0.25 wt % lubricant in Coiled-Tubing synthetic sea-
water fluid, at 150 lbs load and 100 rpm speed

| | Chlorinated level | | | | | |
|---|---|---|---|---|---|---|
| | (%) in the chlorinated hydrocarbons | | | | | |
| | 40% Chlorine | | 50% Chlorine | | 60% Chlorine | |
| | Blank torque, lb-in | | | | | |
| | 30 | 30 | 30 | 30 | 30 | 30 |
| Formula--> | Formula I | Formula II | Formula I | Formula II | Formula I | Formula II |
| Resultant | 14 | 12 | 14 | 11 | 17 | 14 |
| Torques, lb-in | | | | | | |
| % FR | 58% | 64% | 58% | 67% | 48% | 58% |

Testing Results and Discussion:

We did illustrate here that the lubricant blends contain chlorinated hydrocarbons with variety of chlorine levels, being made dispersible in water or low-salt brine, were very effective in reducing friction in coiled-tubing application, through the steel-rubbing-against-steel with Ofite lubricity tester.

What is claimed is:

1. A composition comprising:
91% to 97% by weight a first component; and
3% to 9% by weight of a second component,
the first component having one, two, or three of the following chlorinated-hydrocarbon subcomponents:
the first chlorinated-hydrocarbon subcomponent being a plurality of chlorinated hydrocarbons that range from 35% to 45% by weight chlorine,
the second chlorinated-hydrocarbon subcomponent being a plurality of chlorinated hydrocarbons that range from 45% to 55% by weight chlorine, and
the third chlorinated-hydrocarbon subcomponent being a plurality of chlorinated hydrocarbons that range from 55% to 65% by weight chlorine,
the second component being ethoxylated castor oil, calcium alkylbenzene sulfonate, or a combination thereof.

2. A method comprising the step of:
using the composition of claim 1 as a steel-on-steel friction-reducing lubricant.

3. A method comprising the step of:
adding the composition of claim 1 to a drilling fluid in a coiled-tubing drilling process.

4. The method of claim 3, wherein adding the composition of claim 1 to a drilling fluid in a coiled-tubing drilling process reduces steel-on-steel linear friction by at least 40%.

5. A composition comprising:
50.7% to 56.7% by weight a first component;
0.4% to 6.4% by weight a second component;
5.6% to 11.6% by weight a third component;
25.6% to 31.6% by weight a fourth component; and
2.7% to 8.7% by weight a fifth component,
the first component having one, two, or three of the following chlorinated-hydrocarbon subcomponents:
the first chlorinated-hydrocarbon subcomponent being a plurality of chlorinated hydrocarbons that range from 35% to 45% by weight chlorine,
the second chlorinated-hydrocarbon subcomponent being a plurality of chlorinated hydrocarbons that range from 45% to 55% by weight chlorine, and
the third chlorinated-hydrocarbon subcomponent being a plurality of chlorinated hydrocarbons that range from 55% to 65% by weight chlorine,
the second component being ethoxylated castor oil, calcium alkylbenzene sulfonate, or a combination thereof,
the third component having vegetable methyl esters, biodiesels, methyl fatty esters, methyl oleates, methyl palmitates, or a combination thereof,
the fourth component having polyglycols, ethers, glycols, or a combination thereof, and
the fifth component being tap water.

6. A method comprising the step of:
using the composition of claim 5 as a steel-on-steel friction-reducing lubricant.

7. A method comprising the step of:
adding the composition of claim 5 to a drilling fluid in a coiled-tubing drilling process.

8. The method of claim 7, wherein adding the composition of claim 5 to a drilling fluid in a coiled-tubing drilling process reduces steel-on-steel linear friction by at least 40%.
